(19) United States
(12) Patent Application Publication
(10) Pub. No.: US 2024/0221520 A1
(43) Pub. Date: Jul. 4, 2024

(54) Spiritual Quotient Platform and Method therefor

(71) Applicant: Every Nation Church (Singapore), Singapore (SG)

(72) Inventor: Jose Jorge Jr Aragon BONIFACIO, Singapore (SG)

(73) Assignee: Every Nation Church (Singapore), Singapore (SG)

(21) Appl. No.: 18/558,175

(22) PCT Filed: Dec. 31, 2021
(86) PCT No.: PCT/SG2021/050830

§ 371 Date: Oct. 30, 2023

(30) Foreign Application Priority Data
May 4, 2021 (SG) 10202104645S

(51) Int. Cl. G09B 5/06; G09B 5/02; G09B 5/04; G09B 7/02

(52) U.S. Cl. CPC G09B 5/065; G09B 5/02; G09B 5/04; G09B 7/02

(57) ABSTRACT

The present invention provides a learning management platform for facilitating interactions between users for establishing a learning journey of discipleship of the users. The learning management platform comprises a journey manager for tracking, monitoring, prompting users' progress of the learning journey; a user manager for categorizing and managing the users' progress and privilege levels in a hierarchy of layers, wherein a new user account is created by a user of a higher hierarchy layer; a content manager managing learning materials for the learning journey based on privilege level of the respective users' progress, wherein the privilege level of the respective user is granted based on the users' progress on their respective learning journey or by another associated user of a higher hierarchy layer. The learning management platform comprising the journey manager, user manager, content manager in conjunction with notifications, prompts, and triggers promote the habit building and discipleship learning of a user based on users' progress and privilege level. A method of facilitating interactions between users for establishing a learning journey of discipleship is also provided.

### FIELD OF THE INVENTION

The present invention relates to Spiritual Quotient (SQ) Platform. Specifically, the present invention provides a system and method adapted for discipleship through a SQ Platform.

### BACKGROUND

A study by Pew Research Center 2018 entitled “Why America's ‘nones’ don't identify with a religion” shows that a growing number of Americans are religiously unaffiliated. “Nones” or no religions are segment of individuals who are unaffiliated to any religion, agnostics, atheists and/or syncretizes.

Time magazine's 27 Sep. 2016 wrote “Fewer than half of young adults ages 18 to 30 are sure God exist. In a few years, the largest “religion” in the U.S. will be None.” One most common reason Nones gave were that they questioned a lot of religious teachings but were never properly guided and coached to clear their doubt.

US Published Patent Application no. US2002/0072996A1 discloses a method and apparatus for practicing religious faith through the WWW. Specifically, the religious faith is practiced through paid service comprises proprietary religious audio and visual works and merchandise. The system allows the parishioner to purchase the materials provided therefrom, with the approval from Church. The system also provides a virtual reality Church accessible by the users. The Church may assign virtual watchers who can only monitor but not interact with nor able to know who the subscribing member to monitor any misconduct by the members, and when any misconduct found, the members shall be informed accordingly. In short, the system and method offer a platform of managing the transactions and accessibility of the materials by the members.

It is therefore an objective of the present invention to provide an effective system and method for an interactive platform for discipleship to anyone who is interested.

### SUMMARY

In one aspect of the present invention, there is provided a learning management platform for facilitating interactions between users through the learning management platform on their own communication devices for establishing a learning journey of discipleship of the users. The learning management platform comprises a journey manager for tracking, monitoring, prompting users' progress of the learning journey; an user manager for categorizing and managing the users' progress and privilege levels in a hierarchy of layers, wherein a new user account is created by a user of a higher hierarchy layer; a content manager managing learning materials for the learning journey based on privilege level of the respective users' progress, wherein the privilege level of the respective user is granted based on the users' progress on their respective learning journey or by another associated user of a higher hierarchy layer.

In one embodiment, the learning materials include digital reading materials, audio content and video content.

In another embodiment, the journey manager is adapted to prompt user at a higher hierarchy layers to connect with users thereunder.

In a further embodiment, the learning management platform comprises a Pray feature adapted for recording prayer points on the learning management platform; a Meditate feature for delivering daily content focusing on themes and topics related to the learning journey; and a Proclaim feature including library of content to be granted by another user of higher hierarchy layer.

In yet a further embodiment, the learning management platform comprises a Fellowship feature, which may be unlocked for a user by another user of higher hierarchy layer under the learning management platform.

In another aspect of the present invention, a method for establishing discipleship of users through a learning management platform connectable through users' communication device. The method comprises categorizing users in a plurality of hierarchy layers and categorizing learning materials based on users' progress and hierarchy layers; creating a new user account by a user of a higher hierarchy layer; tracking the user's progress and making learning materials available to the user in accordance with the user's progress; building a user journey habit profile for the new user and tracking the same based on the users' progress; promoting the user to a higher hierarchy layer based on the user's progress to a higher privilege level by at least one user of the higher hierarchy layer; granting access to new learning materials corresponding to the user's progress by at least one user of the higher hierarchy layer. The aforesaid method is carried out under the learning management platform through the users' communication device.

In one embodiment, the method further comprises granting access to new learning materials done by at least one user of higher hierarchy layer.

In another embodiment, the method may further comprise selecting a Pray feature on the learning management platform to assist users in learning to pray; selecting a Meditate feature for receiving daily content to assist users in learning how to meditate on the Bible; and selecting a Proclaim feature to receive content granted by another user of a higher hierarchy layer, to assist users in sharing the spiritual quotient journey.

In yet another embodiment, the method further comprises promoting a user to a higher hierarchy layer by another user of a higher hierarchy layer to unlock Fellowship features only available to users of a higher hierarchy layer.

In a further embodiment, the method comprises prompting reminders to the user to interact with other users.

### BRIEF DESCRIPTION OF THE DRAWINGS

This invention will be described by way of non-limiting embodiments of the present invention, with reference to the accompanying drawings, in which:

FIG. 1 illustrates the SQ Platform in accordance with an embodiment of the present invention;

FIG. 2 illustrates a flowchart of how to engage a person in accordance with an embodiment of the present invention;

FIG. 3 illustrates a flowchart of how a new user registers on the platform in accordance with an embodiment of the present invention;

FIG. 4 illustrates a flowchart of how a new user onboards on the platform in accordance with an embodiment of the present invention;

FIG. 5 illustrates a flowchart of milestone achievement progress in accordance with an embodiment of the present invention;

FIG. 6 illustrates a flowchart of continuing the SQ progress in accordance with an embodiment of the present invention;

FIG. 7 illustrates a flowchart of an SQ Learner becoming an SQ Guide in accordance with an embodiment of the present invention;

FIG. 8 illustrates a flowchart of an SQ Guide's progress in accordance with an embodiment of the present invention;

FIG. 9 illustrates a flowchart of an SQ Guide becoming an SQ Coach and some of the activities they may carry out in accordance with an embodiment of the present invention;

FIG. 10 illustrates a flowchart of the SQ Life progress of an SQ User in accordance with an embodiment of the present invention;

FIG. 11. illustrates the interactions between SQ Users of the different layers on the SQ Platform in accordance with an embodiment of the present invention;

FIG. 12 illustrates a SQ learning process in accordance with an embodiment of the present invention;

FIG. 13 illustrates an account creation process in accordance with an alternative embodiment of the present invention;

FIG. 14 illustrates a process of becoming an SQ Guide in accordance with an embodiment of the present invention;

FIG. 15 illustrates a workflow of SQ Guides in one embodiment of the present invention; and

FIG. 16 illustrates an interaction between two SQ users through the SQ Platform in accordance with an embodiment of the present invention.

### DETAILED DESCRIPTION

In line with the above summary, the following description of a number of specific and alternative embodiments are provided to understand the inventive features of the present invention. It shall be apparent to one skilled in the art, however that this invention may be practiced without such specific details. Some of the details may not be described at length so as not to obscure the invention. For ease of reference, common reference numerals will be used throughout the figures when referring to the same or similar features common to the figures.

The present invention provides systems and methods for aiding a learning experience of a SQ Learner through a communication platform. Embodiments of the present invention include various steps, which will be described below. The steps may be executed under hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present invention may be provided as a computer program product, which may include a machine-readable storage medium tangibly embodying thereon instructions, which may be used to program a computer (or other electronic devices) to perform a process. The machine-readable data storage medium may include, but is not limited to, portable or non-portable storage devices, optical storage devices, and various other mediums capable of storing, containing, or carrying instruction(s) and/or data therein. Examples of the machine-readable storage medium includes fixed (hard) drives, magnetic tape, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Although the present invention has been described with the purpose of facilitating interactions between users through the learning management platform, it should be appreciated that the same has been done merely to illustrate the invention in an exemplary manner and to highlight any other purpose or function for which explained structures or configurations could be used and is covered within the scope of the present invention.

For the purpose of this invention, Spiritual Quotient (SQ) refers to a measure of a person's spiritual awareness and acumen. The present invention facilitates a system and method for a system of training and evaluating the SQ of a person. The system and method are implemented with an aid of an SQ Platform deployable over a communication device. The system and method aim to forge discipleship through relationships, taking into consideration the above current realities, which may turn discipleship into a lifestyle and not just a religious duty or function to be fulfilled.

The platform is adapted to connect religious leaders, believers and learners in a relational manner. The discipleship process may include non-digital means of evangelism, content distribution, and seminars.

The systems and methods aim to facilitate a frictionless experience. Realizing that people are busy with life, the platform is adapted for carrying out discipleship with very little friction in time, effort and energy, thus creating a culture of discipleship that is enjoyable and relational, i.e. a lifestyle. The platform minimizes formal classes while providing new SQ Learners a discipleship journey with online learning materials, such as eBooks and videos. In one embodiment, each completed learning content by the SQ Learner triggers the release of new content.

Most of the time new disciples do not get ample relational support from the person who started them on their discipleship journey. Disciples are not adequately trained themselves and they don't always have the time and energy to do it.

As all the learning content is easily accessible via the platform, the SQ Guides, experienced or not, always have access to the content. The learning content is practical enough to apply them in real life situations. More importantly, the platform is there to remind and enable users to put teachings into practice.

The platform allows the SQ Learners to ask questions to the SQ Guides, of whom, unlike in an in-person meeting, will be more confident to respond to the questions because they have access to relevant resources online. This eliminates conventional physical classes, and online interactions can be done in real-time, on-demand.

In one embodiment, the platform may collect these questions and provide participants with relevant and sound answers which can be used by machine learning, i.e. artificial intelligence (AI), to provide answers automatically when similar questions are posted in the future.

Embodiments of the present invention offers an engaging experience on discipleship through a content creation method with the goal of making the learning points “sticky”, memorable, unforgettable and applicable. The platform, through its built-in design of content, content-feeds, alerts, easy-tracking, and communication systems, would help both SQ Learners and SQ Guides remember what they have learned.
“You then, my son, be strong in the grace that is in Christ Jesus. And the things you have heard me say in the presence of many witnesses entrust to reliable men who will also be qualified to teach others.” (2 Timothy 2:1-2 NIV).

The Apostle Paul (1^{st} generation) speaking to Timothy (2^{nd} generation) to entrust to reliable men (3^{rd} generation) who will be qualified to teach others (4^{th} generation), outlines the layers of discipleship relationships.

That inspired one embodiment of the platform to facilitate aids to carry out discipleship in layers of:
Pastor (1^{st} layer)→SQ Coach (2^{nd} layer)→SQ Guide (3^{rd} layer)→SQ Learner (4^{th} layer)

As the new SQ Learner (at 4^{th} layer) journeys through the discipleship process with the SQ Guide (3^{rd} layer), the 2^{nd} layer of relationships known as SQ Coaches can also lend support to both the SQ Guide and SQ Learner.

Through the platform the SQ Guide, and SQ Coach are informed on the progress of the SQ Learner, and whenever necessary, can arrange to meet in person or online.

The SQ Guide, SQ Coach, and Pastors may receive content and other resources on how to pray for, encourage, and engage with their SQ Learners, SQ Guides, and SQ Coaches respectively.

The above forms a relational discipleship through the present embodiment of the invention.

As SQ Learners go through the platform and complete certain stages, they too can reach out to family and friends.

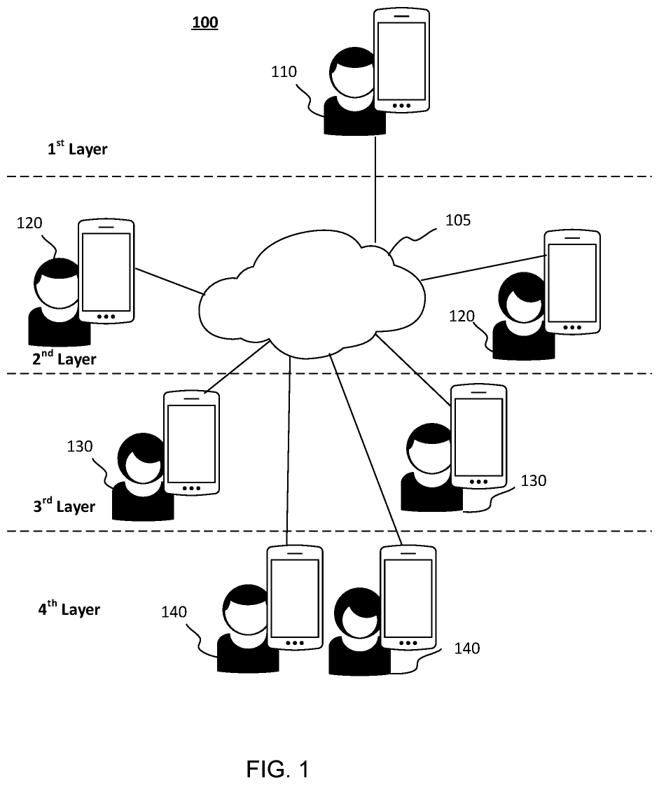

With the above in mind, FIG. 1 illustrates the SQ Platform in accordance with an embodiment of the present invention. The SQ Platform 100 comprises SQ apps deployed on the personal communication devices of the Pastor 110, SQ Coaches 120, SQ Guides 130 and SQ Learners 140 connected to the SQ Platform through the internet 150. The SQ Platform can be deployed on a remote and dedicated private server, or it can be deployed in a Cloud server for better accessibility.

As illustrated, users may be categorized to connect in layers for discipleship, as described above.

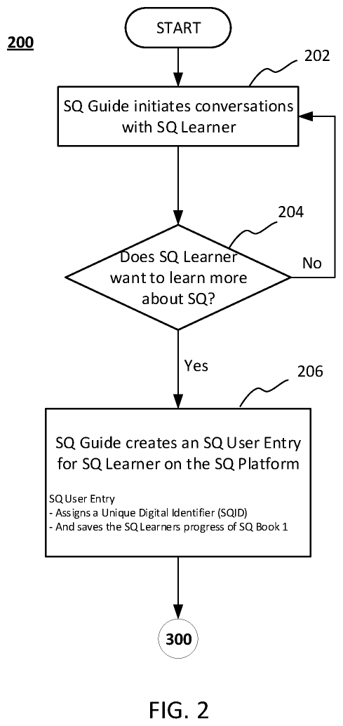

FIG. 2 illustrates a flowchart of a workflow 200 in accordance with an embodiment of the present invention. The workflow 200 starts with a SQ Guide initiating a conversation with a SQ Learner (or potential SQ Learner) at step 202. At step 204, if the SQ Learner does not wish to learn about SQ, the SQ Guide may continue to engage in building the relationship.

If the SQ Learner expresses a desire to learn more about SQ at the step 204, the SQ Guide creates an (new) user entry for the SQ Learner on a SQ Platform at step 206 through the SQ Guide's communication device, such as the mobile phone. The user entry may comprise a unique digital identifier (SQID). After that, the SQ Guide may introduce the SQ Learner to an Intro to SQ content at an introduction process 300.

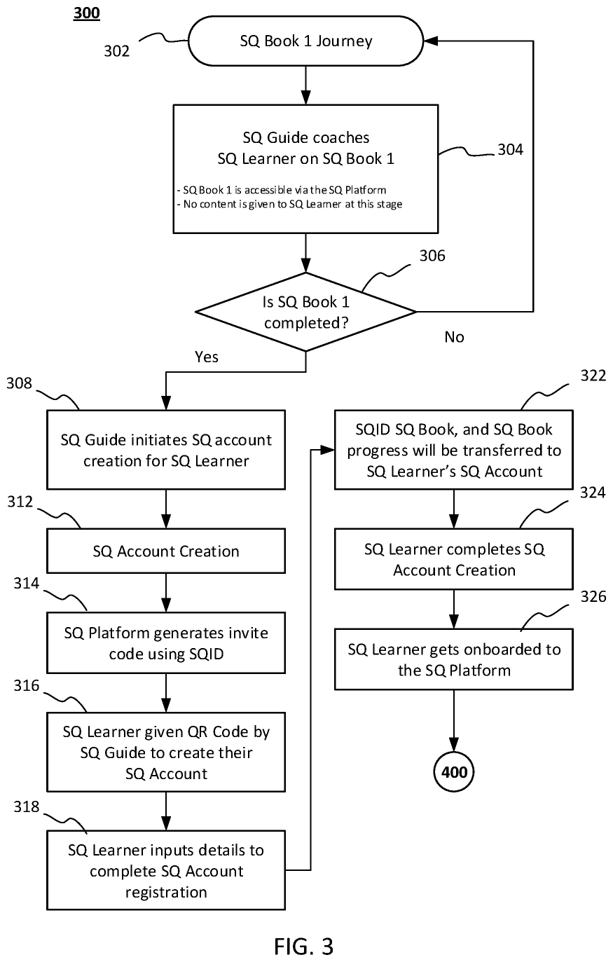

FIG. 3 illustrates a flowchart of the SQ introduction process 300 in accordance with an embodiment of the present invention. At step 302, the SQ Learner is introduced to an “SQ Book 1” journey on an SQ Platform by the SQ Guide, possibly through SQ Guide's communication device. The SQ Book 1 can be any introduction materials, such as eBook or audio/visual content, or combination thereof about the SQ teachings. At step 304, the SQ Guide leads the SQ Learner through the SQ Book 1's content. The SQ Guide leads the SQ Learner by using the SQ content provided by the platform. At this stage, the content may possibly be available solely on the SQ Guide's communication device, i.e. not available to the SQ Learner's device. At step 306, the SQ Platform prompts the SQ Guide to remind them to complete SQ Book 1 with the SQ Learner. If the SQ Guide has not completed the SQ Book 1 with the SQ Learner, the SQ Guide may continue to journey through the content.

In one embodiment, once the SQ Book 1's content is completed, at step 308, the SQ Guide initiates SQ Learner account creation. At step 312, the SQ Guide creates a SQ Learner account with the assigned SQID. At step 314, the SQ Platform generates an invite code using the SQID. In one embodiment, the invite code may be encoded in a QR code or any other generated code. In one embodiment, the invite code may also be shared through email, web link, or any messaging system. At step 316, the SQ Learner receives an account creation invite on his communication device. The process may include downloading an SQ client app onto his communication device to complete the account creation. In one embodiment, at step 318, the SQ Learner inputs personal details to complete SQ account creation. Upon completion, the SQID, SQ content and progress thereof will also be reflected on the SQ Learner's SQ account on the SQ Platform at step 322. At step 324, the SQ account creation is completed, and at step 326, the SQ Learner begins the onboarding process. From this point forward, the SQ Learner may access the SQ Platform on his own communication device.

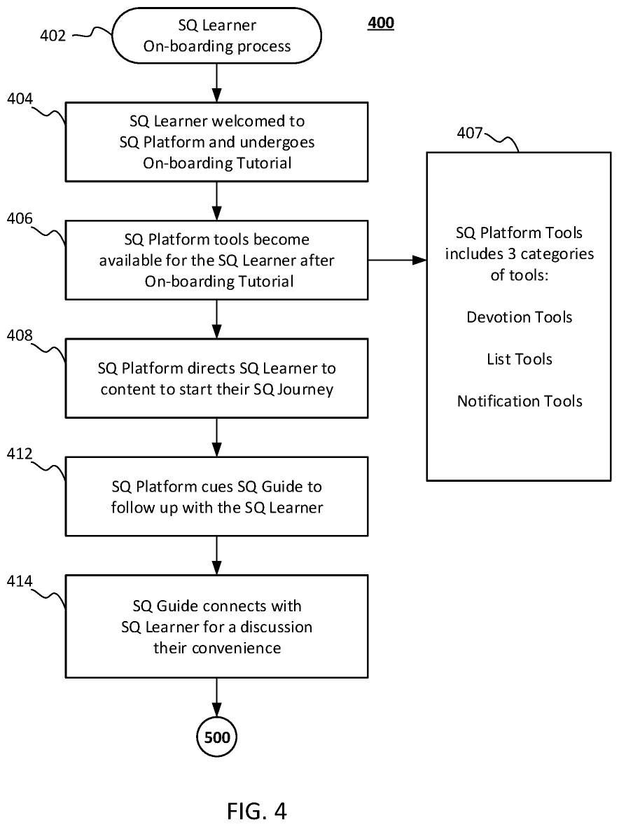

FIG. 4 illustrates a flowchart of a SQ Learner on-boarding process 400 in accordance with an embodiment of the present invention. At step 402, the SQ Learner on-boarding process is started. At step 404, the SQ Learner is welcomed to the SQ Platform through an on-boarding tutorial. The tutorial provides an introduction of the SQ Platform and features available for the SQ Learner. Upon completion of the tutorial, at step 406, the SQ Platform tools become available to the SQ Learner on the SQ client app. The SQ Platform tools 407 may include at least devotion tools, list tools and notification tools. At step 408, the SQ Platform directs the SQ Learner to introductory content to begin their SQ journey. The content will be available on the SQ Platform that can be accessed at any time by the SQ Learner through his own communication device.

At step 412, the SQ Platform cues the SQ Guide to follow up with the SQ Learner. In one embodiment of the present invention, the SQ Platform may prompt and remind the relevant parties to follow up with the SQ Learner.

At step 414, the SQ Guide connects with the SQ Learner for a discussion at their convenience. As the above is progressing, milestone achievement is evaluated at step 500.

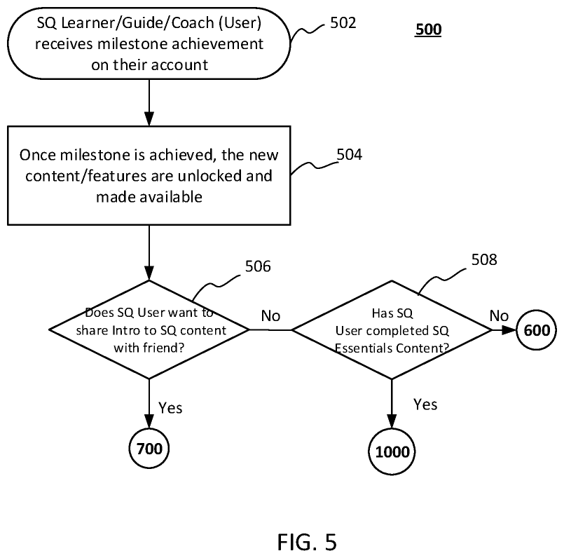

FIG. 5 illustrates a flowchart of milestone achievement evaluation 500 in accordance with an embodiment of the present invention. At step 502, the SQ Users receives milestone achievement on their own account on SQ Platform. The SQ Users referred herein include all users of the platform, including SQ Learners, SQ Guides, SQ Coaches and Pastors. At step 504, corresponding features or learning materials are unlocked or released progressively to the SQ User as a milestone is achieved or accomplished. In one embodiment of the present invention, when the SQ User achieves a prescribed milestone, the SQ User is prompted at step 506 whether he wishes to share the “Intro to SQ” with a friend. If the SQ User does not want to share with a friend, the platform will check at 508 if they have completed an SQ Essentials content. If yes, they will proceed to workflow 1000, if not, they will proceed to workflow 600.

Returning to the step 506, if the SQ Learner wishes to share the SQ journey with a friend, the SQ Learner may proceed with a SQ Guide promotion workflow 700.

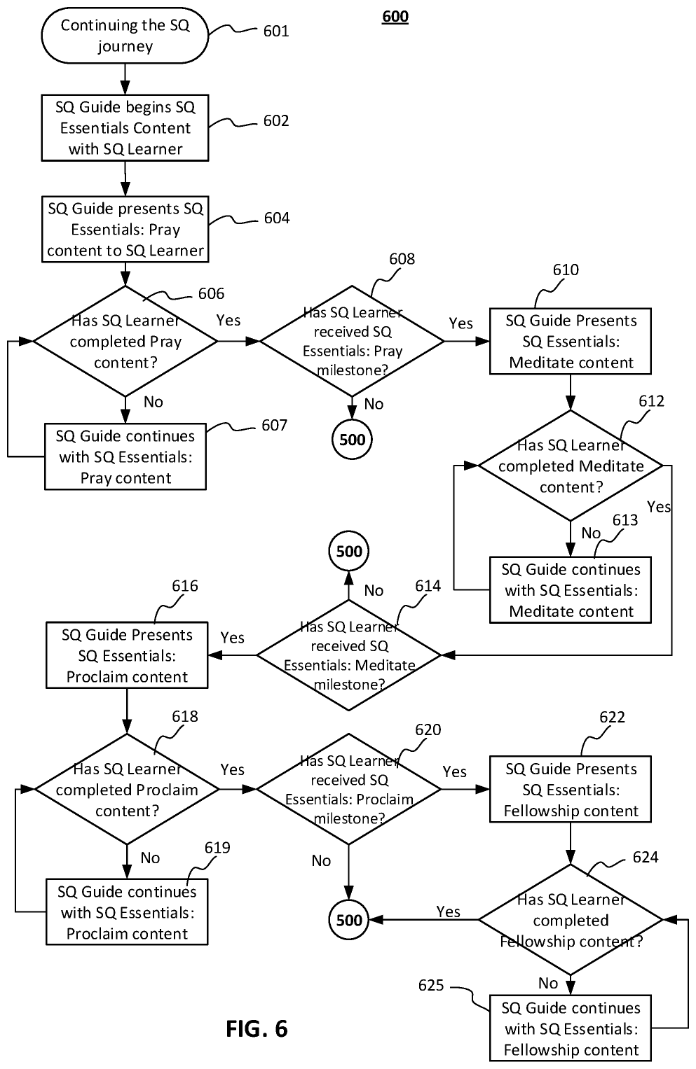

FIG. 6 illustrates a flowchart of the SQ journey process 600 in accordance with an embodiment of the present invention. The SQ journey process 600 starts at step 601, with the SQ Learner continuing the SQ journey. At step 602, the SQ Guide begins SQ Essentials content with the SQ Learner. The SQ Essentials content is available on the SQ Guide's communication device whereby the SQ Essentials content is presented to the SQ Learner thereon. At step 604, the SQ Guide first presents the SQ Essentials Pray content to the SQ Learner. At step 606, the platform checks if SQ Learner has completed the SQ Essentials: Pray content. If not, the SQ Guide continues (to present) the SQ Essentials: Pray content to the SQ Learner at step 607. If the SQ Learner has completed the Pray content with the SQ Guide, at step 608, the platform checks if the SQ Learner has received SQ Essentials: Pray milestone on his account. If not, the platform awards the milestone to the SQ Learner under process 500. If the SQ Learner's milestone has been reported, and the SQ Learner received it on his account, the SQ Guide may proceed to present the SQ Essentials: Meditate content, on the SQ Guide's communication device at step 610.

At step 612, the platform checks if SQ Learner has completed the SQ Essentials: Meditate content. If not, the SQ Guide continues (to present) the SQ Essentials: Meditate content to the SQ Learner at step 613. If the SQ Learner has completed the Meditate content with the SQ Guide, the platform checks if the SQ Learner has received the SQ Essentials: Meditate milestone on his account at step 614. If not, the platform awards the milestone to the SQ Learner under process 500. If the SQ Learner's milestone has been reported, and the SQ Learner has received it on his account, the SQ Guide may proceed to present SQ Essentials: Proclaim content, on the SQ Guide's communication device at step 616.

At step 618, the platform checks if SQ Learner has completed the SQ Essentials: Proclaim content. If not, the SQ Guide continues (to present) the SQ Essentials: Proclaim content to the SQ Learner at step 619. If the SQ Learner has completed the Proclaim content with the SQ Guide, the platform checks if the SQ Learner has received SQ Essentials: Meditate milestone on his account at step 620. If not, the platform awards the milestone to the SQ Learner under process 500. If the SQ Learner's milestone has been reported, and the SQ Learner has received it on his account, the SQ Guide may proceed to present SQ Essentials: Fellowship content, on the SQ Guide's communication device at step 622.

At step 624, the platform checks if SQ Learner has completed the SQ Essentials: Fellowship content. If not, the SQ Guide continues (to present) the SQ Essentials: Fellowship content to the SQ Learner at step 625. If the SQ Learner has completed the Proclaim content with the SQ Guide, the platform awards the milestone to the SQ Learner under process 500.

During the journey where the SQ Guide presents the SQ Essentials content above, the SQ Guide presents the content to the SQ Learners progressively on the SQ Guide's communication device. The SQ Essentials content is unlocked according to the SQ Learner's milestone; and once unlocked, the unlocked SQ Essentials content is available on the SQ Learner's account, which allows the SQ Learner to access those SQ Essentials content on his own communication device.

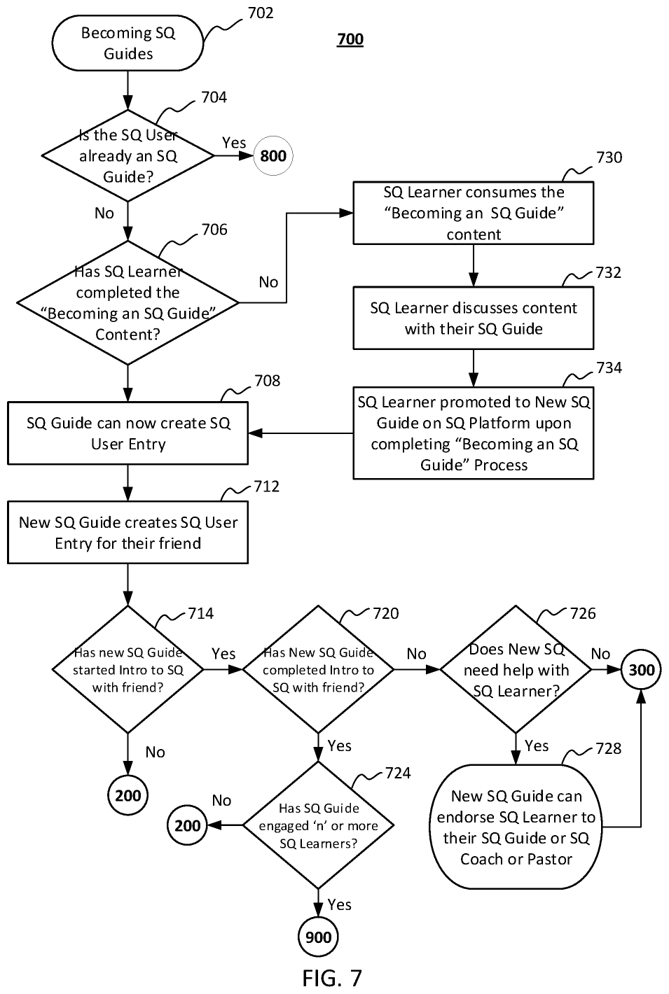

FIG. 7 illustrates a flowchart of Becoming an SQ Guide 700 in accordance with an embodiment of the present invention. At step 702, the process of the SQ Learner becoming an SQ Guide starts. At step 704 the platform checks if the SQ Learner is already an SQ Guide. If he already is, the process continues at workflow 800, which will be described later. If he is not, the platform checks if the SQ Learner has completed a “Becoming an SQ Guide” content at step 706. If the SQ Learner has not completed the content, at step 730 the platform prompts the SQ Learner to complete the “Becoming an SQ Guide” content. At step 732 the SQ Learner discusses content with the corresponding SQ Guide. At step 734 the platform promotes the SQ Learner's status to SQ Guide upon completing the “Becoming an SQ Guide” process and proceeds to step 708. At step 708 the new SQ Guide is granted the feature to create SQ User entries on his SQ Account that he can create for his friends at step 712. The platform checks if the SQ Guide has started the Intro to SQ with a friend at step 714. If the SQ Guide has, the platform checks if they have completed Intro to SQ with a friend at step 720. If the SQ Guide has not completed the Intro to SQ with a friend, the platform can suggest help to the SQ Guide at step 726. SQ Guides may gain assistance from other SQ Guides, SQ Coaches, and/or Pastors as suggested at step 728. If assistance is not required, the process continues at workflow 300. Returning to step 720, if the SQ Guide has completed Intro to SQ with a// friend, the platform checks to see if the SQ Guide has engaged a specified number “n” of SQ Learners at step 724. If the SQ Guide has engaged sufficient SQ Learners the process will proceed to workflow 900. If not, the process will proceed to workflow 200.

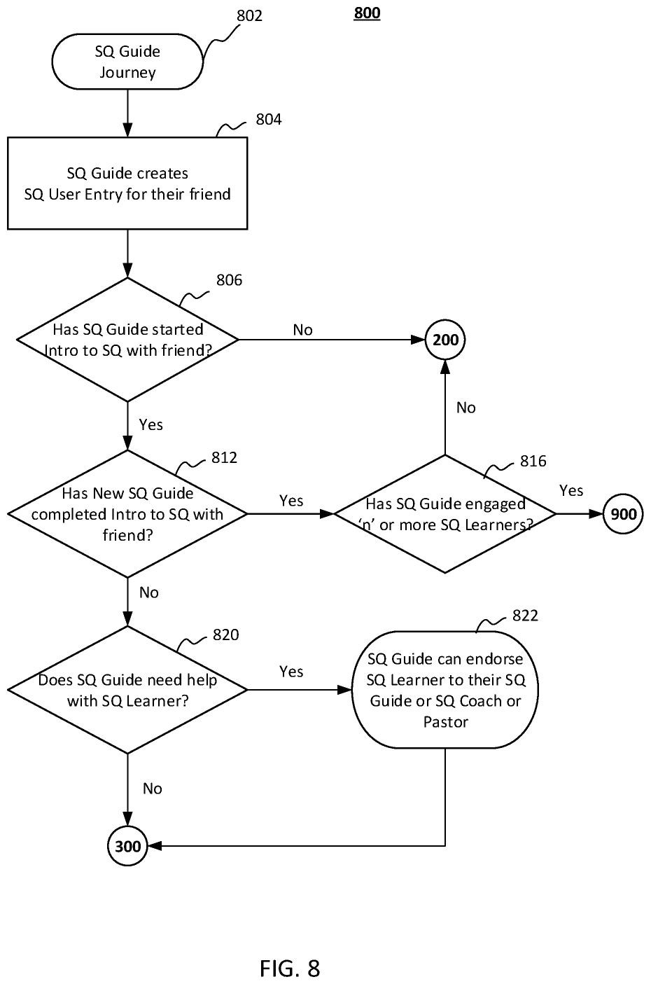

FIG. 8 illustrates a flowchart of an SQ Guide's journey process 800 in accordance with an embodiment of the present invention. At step 804 the SQ Guide is able to create an SQ User entry for a friend he is engaging. The platform checks at step 806 if the SQ Guide has started the “Intro to SQ” content with the friend. If yes, the platform checks at step 812 if the SQ Guide has completed “Intro to SQ” content with this friend. At step 816 the platform checks if the SQ Guide has engaged sufficient number of SQ Learners in order to proceed to workflow 900, i.e. SQ Coach journey, which will be described later below. If not, the process will proceed to workflow 200, i.e. to initiate conversations with (new/potential) SQ Learner. Returning to step 812, if the SQ Guide has not completed “Intro to SQ” content the platform checks if the SQ Guide requires assistance with their friend at step 820. SQ Guides may gain assistance from other SQ Guides, SQ Coaches and/or Pastors as suggested at step 822. In either event, the SQ Guide proceeds to workflow 300, i.e. Intro to SQ content.

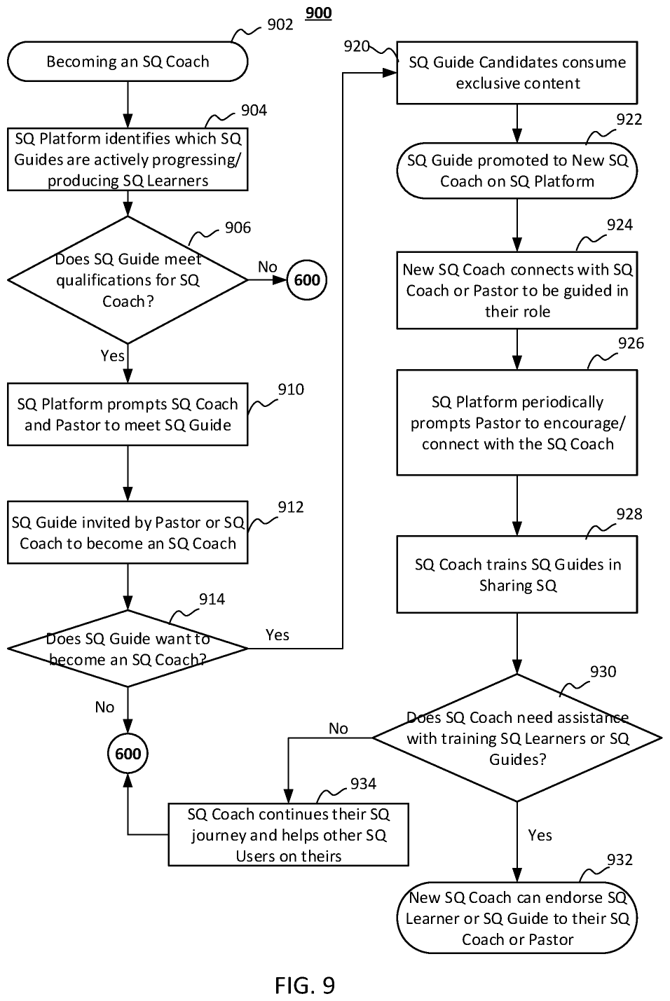

FIG. 9 illustrates a flowchart of an SQ Coach's journey 900 in accordance with an embodiment of the present invention. The journey 900 starts with the SQ Guide promoted as SQ Coach at step 902. At step 904 the platform identifies SQ Guides who are active/progressing/producing SQ Learners. At step 906 the platform determines if the SQ Guides meet the qualifications of SQ Coaches and recommends them to Pastors. At step 910 the platform prompts SQ Coaches and Pastors to connect with qualified SQ Guide. At step 912 qualified SQ Guide is then invited by Pastor or SQ Coach to become an SQ Coach. At step 914, should the candidate desires to become an SQ Coach, he may begin the SQ Coach process and proceed to step 920, where eligible candidates are given access to exclusive content. After completing the content, the SQ Guide is promoted to SQ Coach on the platform at step 922. The new SQ Coach will be guided in their role as coaches by other SQ Coaches and Pastors at step 924. The platform can prompt the Pastor from time to time to encourage and connect with SQ Coaches as described in step 926. The SQ Coach can take on their responsibilities of training SQ Guides in step 928. The platform checks at step 930 if the SQ Coach requires assistance with the training to SQ Learners/Guides. The SQ Coach can gain assistance from other SQ Coaches and Pastors at step 932. Otherwise, the SQ Coach will continue his own SQ journey and assist other SQ Users on theirs as described in step 934. The process continues into workflow 600.

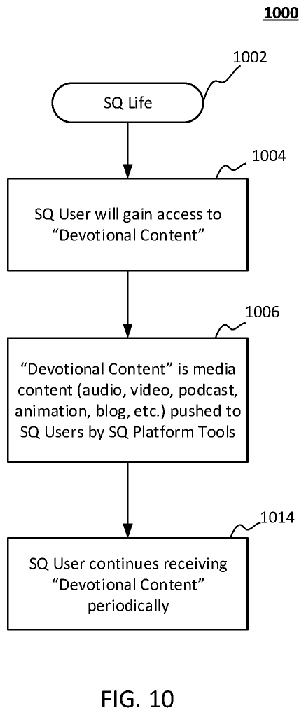

FIG. 10 illustrates a flowchart of the SQ Life process 1000 of the platform in accordance with an embodiment of the present invention. At step 1004 all SQ Users gain access to “Devotional Content” based on the SQ Essentials category completed. “Devotional Content” includes, but is not limited to, audio, video, podcast, animation, blogs, and other kinds of media content which is pushed to the SQ Users by the platform as mentioned in step 1006. “Devotional Content” can be divided into a variety of categories: Spiritual, Relational, Physical, Financial. These categories may expand into further categories and/or sub-categories in one embodiment of the present invention. The SQ User will continue periodically receiving “Devotional Content” as mentioned in step 1014.

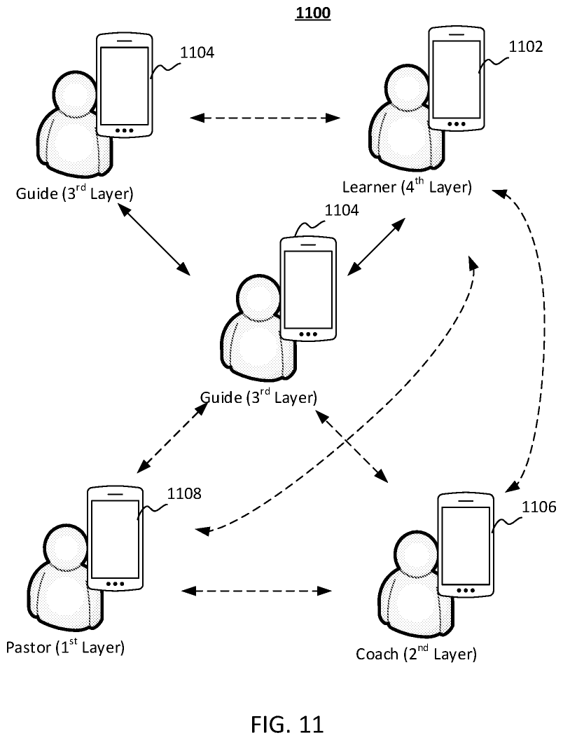

The SQ Platform is designed to allow the SQ Learners, SQ Guides, SQ Coaches and Pastors to collaborate with one another throughout the SQ journey. This is illustrated in FIG. 11.

FIG. 11. illustrates the interactions between SQ Users of the different layers 1100 on the SQ Platform in accordance with an embodiment of the present invention. Pastors, SQ Coaches, SQ Guides and SQ Learners can interact with one another via the platform. These connections are created and tracked on the platform. In an embodiment of this present invention, these connections will enable users to interact with each other as platform features provide them with capabilities to do so. In this embodiment, SQ Learner 1102 is able to communicate with his SQ Guide 1104 and other SQ Guides for his SQ journey. Whenever necessary, the platform allows the SQ Learner 1102 to seek guidance from SQ Guides 1104, SQ Coaches 1106 and Pastors 1108 throughout his learning and promoting journey.

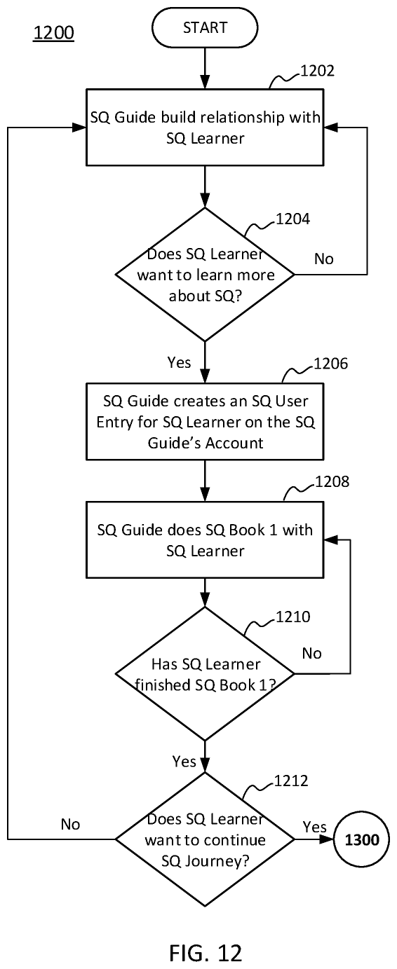

FIG. 12 illustrates a SQ learning process 1200 in accordance with an embodiment of the present invention. In the SQ learning process 1200, a SQ Guide attempts to build relationship with a new (potential) SQ Learner at step 1202. This step is usually done in person between the SQ Guide and the SQ Learner. At step 1204, if the SQ Learner does not have interest to learn about SQ, the SQ Guide may keep in touch with the SQ Learner and follow up with the SQ Learner to see if he wishes to learn about SQ in the future. If the SQ Learner shows the interest to learn about SQ, at step 1206, the SQ Guide creates an SQ User Entry for the SQ Learner on the SQ Guide's account. The creation of the new SQ User Entry can be done through the SQ Platform. It can be done through any computing devices, such as smart phones, that is operationally connectable to the SQ Platform over the communication network. Once the new user entry is created, at step 1208, the SQ Guide does “SQ Book 1” with the SQ Learner. The SQ Guide may record the progress of SQ Learner with the Book. The platform checks if the SQ Learner has finished SQ Book 1 at 1210. If not, the SQ Guide continues doing the SQ Book 1 with the SQ Learner. If the SQ Learner has finished the SQ Book 1, the SQ Learner can decide whether to continue SQ journey at step 1212. If the SQ Learner decides to continue with the SQ journey, the SQ journey progress to process 1300, to complete the SQ Learner account creation.

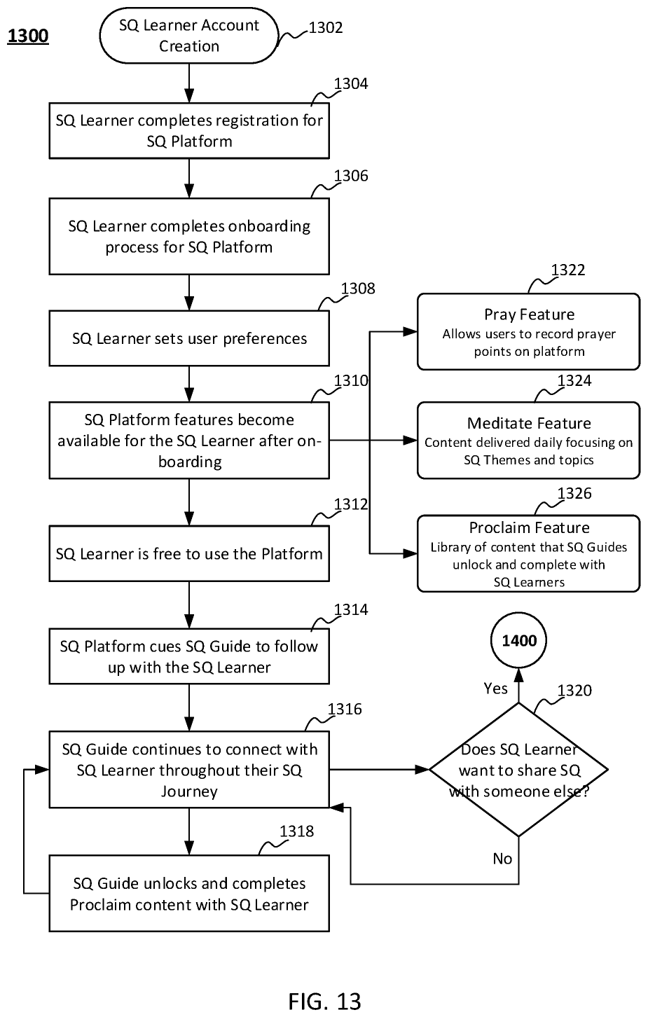

FIG. 13 illustrates an account creation process 1300 in accordance with an alternative embodiment of the present invention. The SQ Learner account creation starts at step 1302 when the SQ Learner decides to continue with the SQ journey. At step 1304, SQ Learner triggers to completes registration for SQ Platform on his own communication device. At step 1306, the SQ Learner provides his personal particulars to the SQ Platform. At step 1308, the SQ Learner sets user preferences, to complete the user on-boarding process. At step 1310, some of features on the SQ Platform become available for the SQ Learner after on-boarding. In particular, the Pray feature 1322, the Meditate feature 1324 and the Proclaim feature 1326 are now available to the SQ Learner.

The Pray feature 1322 allows users to record prayer points on the SQ Platform. The Meditate feature 1324 delivers SQ content daily according to SQ themes and topic. The Proclaim feature 1326 provides library of content of SQ journey. The content of SQ journey may further be controlled by the SQ Guide and allow the SQ Guide to unlock (more content) and complete with the SQ Learner.

Returning to step 1310, all the unlocked features can be accessed by the SQ Learner anytime using the platform at step 1312. At step 1314, the SQ Platform cues the SQ Guide to follow up with the SQ Learner to check on his progress. At step 1316, the SQ Guide continues to connect with SQ Learner through their SQ journey. At step 1318, the SQ Guide unlocks and completes more Proclaim content with SQ Learner. The steps 1316 and 1318 are repeated until all the features of Proclaim feature are unlocked at 1326. During the SQ Learner's journey, at step 1320, the SQ Learner is prompted by the platform and/or the SQ Guide to share SQ with others. If he does, the SQ Learner progresses to become an SQ Guide at 1400. If not, he continues his SQ journey with his SQ Guide.

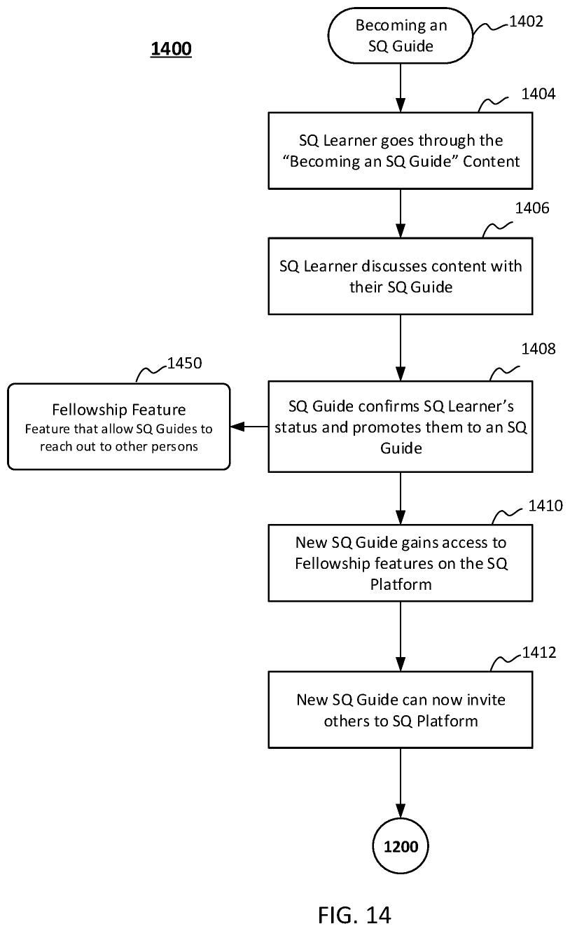

FIG. 14 illustrates a process of becoming an SQ Guide 1400 in accordance with an embodiment of the present invention. The process 1400 starts at step 1402 for becoming an SQ Guide. At step 1404, the SQ Learner goes through the “Becoming an SQ Guide” content. At step 1406, the SQ Learner may discuss the content with his SQ Guide. The discussion may be done in person or remotely. Following that, at step 1408, the SQ Guide confirms SQ Learner's status and when appropriate, promotes the SQ Learner to an SQ Guide. As the SQ Learner is promoted to SQ Guide, the Fellowship feature 1450 become available to the newly promoted SQ Guide. This feature allows SQ Guide to reach out to other persons. At step 1410, the new SQ Guide gains access to the Fellowship features on the SQ Platform. At step 1412, the SQ Guide can now invite others to the SQ Platform. The SQ Guide may now guide the new SQ Learner as aforementioned.

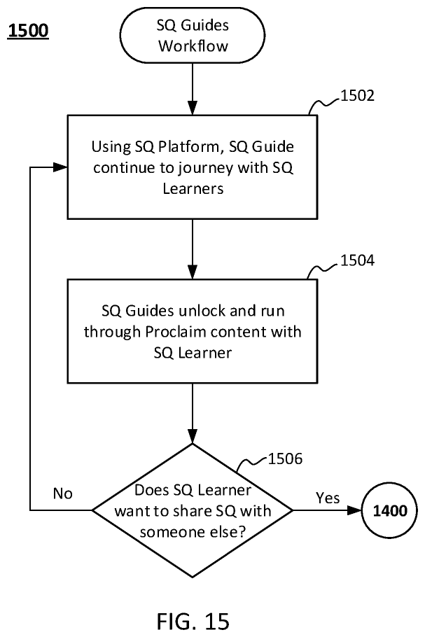

FIG. 15 illustrates a workflow of SQ Guides 1500 in one embodiment of the present invention. At step 1502, the SQ Guide continues to SQ journey with SQ Learners using the SQ Platform. At step 1504, the SQ Guide may unlock and run through Proclaim content with the SQ Learner, when appropriate. At step 1506, SQ Learner (now promoted as SQ Guide) is checked with he wants to share SQ with others.

The present invention offers a computer network having a communication platform to aid in a learning process. Users or subscribers of the communication platform may connect to the communication platform via any communication devices, such as smart phone, tablet device, etc. Through the aid of the communication platform, the SQ Guide/Coach/Pastor coaches a new SQ Learner and promotes the SQ Learner through the communication platform over the SQ journey. The SQ Learner may be promoted to SQ Guide, then further to SQ Coach and further to Pastor as they have established stronger discipleship and have more influence to enroll new learners in the platform.

The SQ Learner progresses through the SQ journey with the SQ materials stored on the platform. SQ materials are progressively unlocked for access by the SQ Learner. The SQ Guide/Coach/Pastor controls the release of SQ materials based on the SQ Learner's SQ journey progress. While the SQ Guide/Coach/Pastor would need personal interaction with the SQ Learner on their SQ journey from time to time, the SQ User may utilize various features available on the platform to share, post and discuss thoughts and comments to enhance the SQ journey experience and understanding.

All SQ users' progress in their SQ journey are recorded on the platform and the corresponding SQ Guide/Coach/Pastor are informed periodically and are reminded to follow up with and assist the SQ Learners on their SQ journey.

The platform comprises a journey manager for tracking, monitoring, prompting users of learning journey; a user manager for categorizing and managing users' progress and privilege levels in a hierarchy of layers; a content manager for managing learning materials based on the privilege level of the respective users' progress, wherein the privilege level of the respective user is granted according to the user's progress on their learning journey or by another associate user of a higher hierarchy layer.

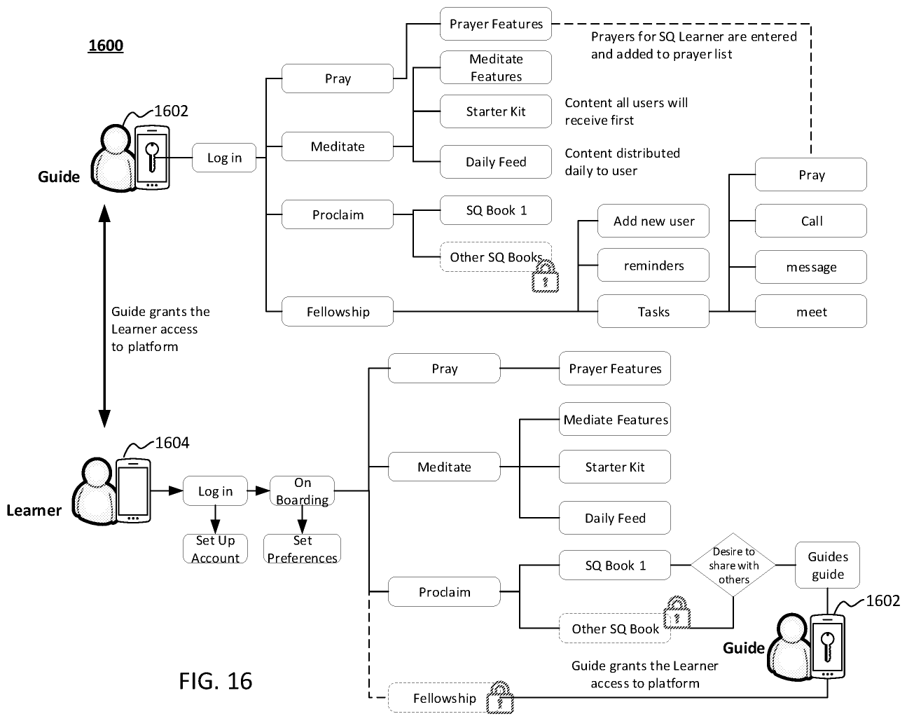

FIG. 16 illustrates an interaction between two SQ users through the SQ Platform in accordance with an embodiment of the present invention. The SQ users include a SQ Guide 1602 and a SQ Learner 1604 and the interactions are carried out through the SQ Platform accessible by SQ Users' communication devices. In general, all SQ users would gain access to all features and functionalities of the SQ Platform progressively. SQ users at higher hierarchy layer, i.e. SQ Guide/Coach/Pastor may further unlock features accessible by SQ Users at a lower hierarchy layer.

As shown, the SQ Guide 1602 grant access to open a new account for a new SQ Learner 1604 to access the SQ Platform. When the SQ Learner first accesses his account, he sets up the account by providing his personal particulars. The platform then brings the SQ Learner 1604 through an on-boarding process, which includes setting user preferences. Once the SQ Learner 1604 is on-boarded, the SQ Learner may utilize the SQ Platform to aid in their SQ journey.

Upon entering the SQ Platform, the Pray feature, Meditate feature and Proclaim feature are accessible to the SQ Users. These features offer functions and digital learning materials for enriching the users' SQ journey. The Pray feature allows SQ Users to record their prayers on the platform, tracks if they have prayed it during the day and archives the prayers if they have been answered. The Meditate feature delivers short content pieces periodically to the SQ users. The content is aimed to grow a user's Spiritual Quotient. The Proclaim feature provide learning materials, such as SQ Book 1, of which, the content thereof may be locked/unlocked according to the progress of the users' SQ journey. The lock/unlock of the content may also be granted by SQ Guide 1602. The Fellowship feature on the SQ Platform is available to a SQ Learner 1604 when the SQ Guide 1602 grant access to the SQ Learner. A SQ Learner 1604 is given an opportunity to gain access to the Fellowship feature when he opts to become a SQ Guide by sharing SQ with others.

Under the Fellowship features, it includes an add new user option, reminders option and tasks option. Under the tasks option, the SQ Guide may pray, call, message and meet the SQ Learner 1604 through the platform.

While specific embodiments have been described and illustrated, it is understood that many changes, modifications, variations and combinations thereof could be made to the present invention without departing from the scope of the invention.

1. A learning management platform for facilitating interactions between users through the learning management platform on their own communication devices for establishing a learning journey of discipleship of the users, the learning management platform comprising:
a journey manager for tracking, monitoring, prompting users' progress of the learning journey;
a user manager for categorizing and managing the users' progress and privilege levels in a hierarchy of layers, wherein a new user account is created by a user of a higher hierarchy layer; and
a content manager managing learning materials for the learning journey based on privilege level of the respective users' progress, wherein the privilege level of the respective user is granted based on the users' progress on their respective learning journey or by another associated user of a higher hierarchy layer.

2. The learning management platform according to claim 1, wherein the learning materials include digital reading materials, audio content and video content.

3. The learning management platform according to claim 1, wherein the journey manager is adapted to prompt user at a higher hierarchy layers to connect with users thereunder.

4. The learning management platform according to claim 1, further comprising:
a Pray feature adapted for recording prayer points on the learning management platform;
a Meditate feature for delivering daily content focusing on themes and topics related to the learning journey; and
a Proclaim feature including library of content to be granted by another user of higher hierarchy layer.

5. The learning management platform according to claim 1, further comprising a Fellowship feature, which the user can unlock when the user is promoted to a higher hierarchy layer under the learning management platform.

6. A method for establishing discipleship of users through a learning management platform connectable through users' communication device, the method comprising:
categorizing users in a plurality of hierarchy layers and categorizing learning materials based on users' progress and hierarchy layers;
creating a new user account by a user of a higher hierarchy layer;
tracking the user's progress and making learning materials available to the user in accordance with the user's progress;
building a user journey habit profile for the new user and tracking the same based on the users' progress;
promoting the user to a higher hierarchy layer based on the user's progress to a higher privilege level by a user of a higher hierarchy layer;
granting access to new learning materials corresponding to the user's progress by at least one user of the higher hierarchy layer;
wherein the aforesaid method is carrying out under the communication platform through the users' communication device.

7. The method according to claim 6, wherein granting access to new learning materials is done by at least one user of higher hierarchy layer.

8. The method according to claim 6, further comprising:
selecting a Pray feature on the leaning management platform to record prayers;
selecting a Meditate feature for receiving daily content; and
selecting a Proclaim feature to receive content granted by another user of the hierarchy layer.

9. The method according to claim 6, further comprising;
promoting a user to a higher hierarchy layer by a higher hierarchy layer to unlock a Fellowship feature for interacting with other users.

10. The method according to claim 6, further comprising prompts reminding the user to interact with other users.
